(19) United States
(12) Patent Application Publication
(10) Pub. No.: US 2007/0064663 A1
(43) Pub. Date: Mar. 22, 2007

(54) Front-end module for wire-free communication means

(76) Inventor: Klaus Dahlfeld, Hebertshausen (DE)

Correspondence Address: BAKER BOTTS, L.L.P., 98 SAN JACINTO BLVD., SUITE 1500, AUSTIN, TX, 78701-4039, US

(21) Appl. No.: 11/532,958

(22) Filed: Sep. 19, 2006

(30) Foreign Application Priority Data
Sep. 19, 2005 (DE) 10 2005 044 620.5

(51) Int. Cl. H04Q 7/24

(52) U.S. Cl. 370/338; 455/574

(57) ABSTRACT

A front-end module (101) has an input (6) for reception of transmission signals from an apparatus (3) for production of transmission signals, and an output (15) for outputting the transmission signals to an antenna (5). The module has further an amplifier stage (11) which is connected in the signal path between the first input (6) and the output (15), and has a bypass line (103) which can optionally be connected in the signal path, for bypassing the amplifier stage (11), with the amplifier stage (11) being switched off when a bypass line (103) is connected in the signal path.

### PRIORITY

This application claims priority from German Patent Application No. DE 10 2005 044 620.5, which was filed on Sep. 19, 2005, and is incorporated herein by reference in its entirety.

### TECHNICAL FIELD

The invention relates to front-end modules for wire-free communication means.

### BACKGROUND

Front-end modules are autonomous components which, in the case of mobile radio applications, are connected to the outputs of the integrated radio-frequency integrated circuits (ICs). In this case, the front-end modules represent the linking element between the RF-IC and the antenna. Both the signals received from the antenna and the signals to be transmitted via the antenna, and which have already been mixed to the transmission frequency in the RF-IC, pass the front-end modules. Since, however, only the signals to be transmitted are relevant for the present invention, the following descriptions will concentrate on these transmission signals.

In addition to switches by means of which it is possible to select between various outputs from the connected RF-IC or RF-ICs front-end modules generally also have power amplifiers in order to make it possible to suitably amplify the transmission signals, which have already been mixed onto the carrier frequency. If the maximum output power of the power amplifier is not required at the antenna, and the RF-IC is able to provide sufficient output power, the output power of the power amplifier can be reduced. A situation such as this may occur, for example, when the radio receiver is located in the physical proximity of the antenna. However, this situation has the disadvantage that the power amplifier still always draws a quiescent current when the antenna output power corresponds to the maximum output power of the RF-IC.

### SUMMARY

A front-end module may consumes less power than conventional front-end modules when the antenna output power corresponds to the maximum output power of the RF-IC which is connected to the front-end module. Such a front-end module may be in an integrated transmitting apparatus. A front-end module may comprise a first input for reception of transmission signals from an apparatus for production of transmission signals, a first output for outputting the transmission signals to an antenna, an amplifier stage which is connected in the signal path between the first input and the first output, for amplification of the transmission signals, and a bypass line which can optionally be connected in the signal path, for bypassing the amplifier stage, with the amplifier stage being switched off when a bypass line is connected in the signal path.

### BRIEF DESCRIPTION OF THE DRAWINGS

The invention will be explained in more detail in the following text using examples and with reference to the drawings in which:

FIG. 1 shows a block diagram of a transmitting apparatus 1 according to the prior art,

FIG. 2 shows a block diagram of a transmitting apparatus 100 as a first exemplary embodiment of the transmitting apparatus; and

FIG. 3 shows a block diagram of a transmitting apparatus 200 as a second exemplary embodiment of the transmitting apparatus.

### DETAILED DESCRIPTION

The front-end module according to an embodiment is intended to be connected to the output of an apparatus which produces transmission signals. This apparatus may, for example, be an RF-IC of a transmitting apparatus, which produces RF signals which have already been mixed onto the transmission frequency, as transmission signals. The transmission signals are received by the front-end module at a first input. The apparatus which produces the transmission signals is thus not necessarily part of the subject matter of the invention. Furthermore, the front-end module is generally an autonomous component, and is not integrated in the RF-IC.

A front-end module also may have an amplifier stage which, for example, is formed by a power amplifier. The amplifier stage can be used to amplify, as required, the transmission signals which are received at the first input and in some circumstances are processed further. The transmission signals which have been amplified in this way may be supplied to a first output of the front-end module, after further processing which may be provided. During transmission, the first output at the front-end module is connected to an antenna which transmits the transmission signals.

A bypass line can optionally be connected and can be used to allow the transmission signals which have been received at the first input to bypass the amplifier stage and accordingly to be supplied to the antenna without passing through the amplifier stage. This means that the user can decide, depending on the circumstances, whether the transmission signal should pass through the amplifier stage before being transmitted by the antenna, or should be supplied directly to the antenna, without further amplification. The latter case may be worthwhile, for example, when the power at the input of the front-end stage is already sufficient for transmission via the antenna. In consequence, in this case, the amplifier stage can be switched off, that is to say it can be disconnected from its supply voltage, and the signal path can be diverted onto the bypass line. The advantage of this measure is that switching off the amplifier stage reduces the current drawn by the front-end module.

A control unit can be advantageously provided in order to control the bypass line and to connect and disconnect the amplifier stage. Although the control unit may be located in the front-end module, it is preferably integrated in an external IC, for example the baseband IC. The control signals produced by the control unit can be received at at least one second input of the front-end module.

The connection with the bypass line and the process of switching off the amplifier stage associated with it can be preferably carried out as a function of the power required at the antenna. This means that, as soon as the power which is required at the antenna can actually be provided at the first input, the amplifier stage is not required, and the transmission signals can be passed to the antenna via the bypass line.

One advantageous refinement according to an embodiment provides for the bypass line to be connected in the signal path via at least one controllable switch. The at least one controllable switch may be advantageously controlled by the control unit.

One or more filters can preferably be connected in the signal path of the transmission signals. In one embodiment, both the amplifier stage and the first output of the front-end module may each be preceded by a bandpass filter.

The apparatus for production of transmission signals preferably produces transmission signals at a plurality of outputs. The front-end module thus has at least one third input, at which further transmission signals can be received. By way of example, 2.4 GHz transmission signals can be received at the first input, and 5 GHz transmission signals can be received at the third input.

The front-end module can preferably be designed such that it passes transmission signals from more than one apparatus for production of transmission signals to the antenna. In this case, the front-end module has at least one fourth input for reception of transmission signals from a further apparatus for production of transmission signals.

Furthermore, received signals which have been received from the antenna can also advantageously be passed from the front-end module to an apparatus for processing received signals. In this case, the received signals are fed into the front-end module at a fifth input, and are output at at least one second output.

According to one embodiment, a part of a signal path which is actually provided for other signals can be used as a bypass line. For example, this signal path may be the transmission signal path between the at least one third input or the at least one fourth input and the first output of the front-end module. Alternatively, however, it is also possible to use a reception signal path as a bypass line at times. By way of example, this can be done using the reception signal path between the fifth input and the at least one second output.

The transmission signals are preferably based on the WLAN and/or Bluetooth Standard. However, it would also be feasible for the front-end module to be provided for transmitting and receiving apparatuses which process signals based on the GSM or DECT Standard.

The transmitting apparatus has both an apparatus for production of transmission signals and the front-end module. Furthermore, further apparatuses for production of transmission signals may be provided, and are connected to the front-end module.

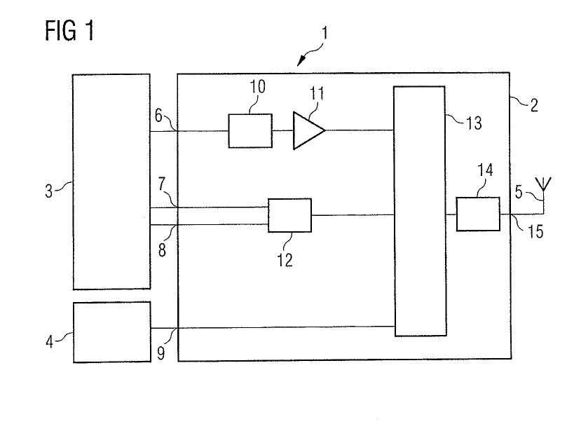

FIG. 1 shows a transmitting apparatus 1 with a conventional front-end module 2. In addition to the front-end module 2, the transmitting apparatus 1 also has RF-ICs 3 and 4 as well as an antenna 5. Furthermore, the transmitting apparatus 1 may also have further assemblies, such as one or more baseband ICs, which are illustrated in FIG. 1. In the present example, the RF-IC 3 supplies WLAN transmission signals, while the RF-IC 4 generates transmission signals which are based on the Bluetooth standard.

The output of the RF-IC 3 is connected to one input 6 of the front-end module 2. Furthermore, outputs 7 and 8 of the front-end module 2 are connected to inputs of the RF-IC 3. The output of the RF-IC 4 is connected to one input 9 of the front-end module 2. The transmission signals, which are received at the inputs 6 and 9 of the front-end module 2, represent transmission signals which have already been mixed onto the transmission frequency in the RF-ICs 3 and 4. Bluetooth received signals also pass via the connection 9, in addition to the Bluetooth transmission signals.

A bandpass filter 10 and a power amplifier 11 are connected in series downstream from the input 6. The outputs 7 and 8 represent differential outputs. Received signals which have already been received by the antenna 5 and have been transformed by means of a transformer 12 (balun; balanced-unbalanced) to differential signals are output at the outputs 7 and 8. The output of the power amplifier 11, the input of the transformer 12 and the input 9 are connected to the inputs of an SP3T switch 13 (single pole/triple throw). On the output side, the SP3T switch 13 is connected via a further bandpass filter 14 to an output 15 of the front-end module 2 to which the antenna 5 is connected.

The SP3T switch 13 is used to select one channel which is applied to its three inputs and is intended to be connected to the antenna 5. For this purpose, the SP3T switch 3 has a control input, which is not illustrated in FIG. 1. The SP3T switch 13 is driven by a control unit via this control input. The control unit is generally not located in the front-end module 2, but is, for example, arranged on one of the RF-ICs 3 or 4, or on the baseband IC.

The problem on which the invention is based relates to the transmission signals which are provided at the input 6, and their amplification by the power amplifier 11. The WLAN transmission signals are produced by the RI-IC 3 at 0 dBm and are amplified to about 20 dBm by the 2.4 GHz power amplifier 11. However, the maximum output power from the power amplifier 11 is not required at the antenna 5, the output power of the power amplifier 11 may be reduced. The problem in this case is that the power amplifier 11 still draws a quiescent current when the output power at the antenna corresponds to the maximum possible output power of the RF-IC 3. In the case of a WLAN in the 2.4 GHz range, this quiescent current is about 60 mA. The RF-IC 3 requires about 100 mA during transmission, so that the current drawn by the transmitting apparatus 1 in this case amounts to a total of about 160 mA.

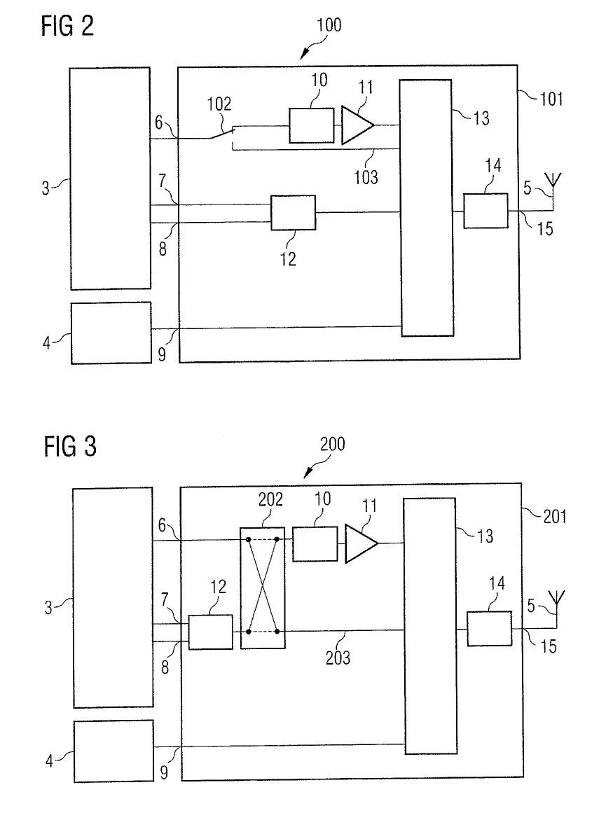

FIG. 2 illustrates a transmitting apparatus 100 which solves the problem described above. The transmitting apparatus 100 differs from the transmitting apparatus 1 shown in FIG. 1 primarily by having a front-end module 101 of different design, which acts as a first exemplary embodiment of the front-end module. Otherwise, the transmitting apparatus 100 largely corresponds to the transmitting apparatus 1. The identical assemblies in the transmitting apparatuses 1 and 100 in FIGS. 1 and 2 are thus annotated with the same reference signs. In this context, reference is made to the above description of these assemblies.

The front-end module 101 of the transmitting apparatus 100 contains an SP2T switch 102 (single pole/double throw), in contrast to the front-end module 2 in the transmitting apparatus 1. The SP2T switch 102 is arranged between the input 6 of the front-end module 101 and the bandpass filter 10, to be precise in such a way that the input 6 is connected either to the input of the bandpass filter 10 or, via a bypass line 103 to one input of an SP4T switch 104 (single pole/quadruple throw), depending on the switch position of the SP2T switch 102. The SP4T switch 104 shown in FIG. 2 corresponds to the SP3T switch 13 shown in FIG. 1, with the difference that the SP4T switch 104 has an additional input, to which the bypass line 103 is connected.

In the situation in which the output power of the RF-IC 3 is sufficient and no more amplification by means of the power amplifier 11 is required, the bypass line 103 allows the transmission signals received at the input 6 to be supplied to the antenna 5 without having to pass through the power amplifier 11. In consequence, the power amplifier 11 can be switched off in this case. Since the power amplifier 11 thus does not draw any quiescent current, this corresponds to a current draw saving of 60 mA.

If the antenna 5 requires a higher output power than the RF-IC 3 can produce, the power amplifier 11 can be switched on again, and the SP2T switch 102 as well as the SP4T switch 104 can be switched appropriately. In this case, the transmitting apparatus 100 is operated in the same way as the transmitting apparatus 1.

A control unit is provided in order to control the SP2T switch 102 as well as the SP4T switch 104 and to connect and disconnect the power amplifier 11. This control unit is generally not located in the front-end module, but, by way of example, is accommodated in the baseband IC or in one of the RF-ICs 3 or 4. In order to communicate with the control unit, the front-end module 101 has control inputs, which are not illustrated in FIG. 2, into which the appropriate control signals are fed in order to control the SP2T switch 102 as well as the SP4T switch 104 and the power amplifier 11.

FIG. 3 illustrates a transmitting apparatus 200 which, with a front-end module 201, contains a second exemplary embodiment of the front-end module. The assemblies which are identical to assemblies from FIG. 1 are also annotated with the same reference signs in FIG. 3.

In contrast to the front-end module 2, the front-end module 201 contains a DPDT switch 202 (double pole/double throw). The DPDT switch 202 is arranged such that, depending on the switch position, either the input 6 is connected to the input of the bandpass filter 10 and the input of the transformer 12 is connected to the central connection of the SP3T switch 13, or the input 6 is connected to the central connection of the SP3T 13, which is otherwise provided for the transformer 12. In consequence, in the latter case, the connecting line 203 between the DPDT switch 202 and the central connection of the SP3T switch 13 represents the bypass line. In this case as well, the bypass line 203 is once again used in order to make it possible to bypass the power amplifier 11 when required, in order that it can be switched off.

The DPDT switch 202 and the power amplifier 11 and the transmitting apparatus 200 are controlled in precisely the same way as the transmitting apparatus 100, via a control unit.

In FIG. 3, a part of the reception signal path is used as the bypass line. As an alternative to this, it is also feasible for the signal path which leads from the RF-IC 4 via the connection 9 to the SP3T switch 13 to be used as the bypass line. In this case, the lower two connections of the DPDT switch 202 would have to be connected in this signal path.

A further embodiment may include the RF-IC 3 outputting 5 GHz transmission signals in addition to the 2.4 GHz transmission signals at a further output, which is not shown in the drawings. A further transmission signal path would have to lead from this output through the front-end module 201 to the antenna 5. A part of this transmission signal path could likewise be used as a bypass line at times.

What is claimed is:

1. A front-end module comprising
a first input for reception of transmission signals from an apparatus for production of transmission signals,
a first output for outputting the transmission signals to an antenna,
an amplifier stage which is connected in the signal path between the first input and the first output, for amplification of the transmission signals, and
a bypass line which can optionally be connected in the signal path, for bypassing the amplifier stage, with the amplifier stage being switched off when a bypass line is connected in the signal path.

2. The front-end module according to claim 1, comprising
at least one second input for reception of at least one control signal for controlling the bypass line and connection and disconnection of the amplifier stage.

3. The front-end module according to claim 1, comprising
at least one controllable switch, by means of which the bypass line is connected in the signal path.

4. The front-end module according to claim 2, wherein
the at least one controllable switch is controlled by means of the at least one control signal.

5. The front-end module according to claim 1, wherein
the amplifier stage is preceded by a first filter, in particular a bandpass filter, in the signal path.

6. The front-end module according to claim 1, wherein
the first output of the front-end module is preceded by a second filter, in particular a bandpass filter, in the signal path.

7. The front-end module according to claim 1, comprising
at least one third input for reception of further transmission signals from the apparatus in order to produce transmission signals.

8. The front-end module according to claim 1, comprising
at least one fourth input for reception of transmission signals from a further apparatus for production of transmission signals.

9. The front-end module according to claim 1, wherein
the front-end module has a fifth input for reception of received signals from an antenna, and
the front-end module has at least one second output for outputting received signals to an apparatus for processing received signals.

10. The front-end module according to claim 7, wherein
a part of the signal path between the at least one third input and the first output of the front-end module is used as the bypass line.

11. The front-end module according to claim 8, wherein
a part of the signal path between the at least one fourth input and the first output of the front-end module is used as the bypass line.

12. The front-end module according to claim 9, wherein
a part of the signal path between the fifth input and the at least one second output is used as the bypass line.

13. The front-end module according to claim 1, wherein
the transmission signals which are received at the first input are based on the WLAN standard.

14. The front-end module according to claim 8, wherein the transmission signals which are received at the at least one fourth input are based on the Bluetooth standard.

15. A transmitting apparatus having an apparatus for production of transmission signals and having a front-end module according to claim 1, with the apparatus for production of transmission signals being designed such that it produces transmission signals and feeds these signals to the first input of the front-end module.

16. A transmitting apparatus according to claim 15, comprising
a further apparatus for production of transmission signals, which is designed such that it produces further transmission signals and feeds these signals to the at least one fourth input of the front-end module.

17. A transmitting apparatus according to claim 15, comprising
an antenna for transmission of transmission signals, with the antenna being connected to the output of the front-end module.

18. A method comprising the steps of:
receiving transmission signals in the frontend module at a first input from an apparatus for production of transmission signals,
outputting the transmission signals to an antenna at a first output,
amplifying the received transmission signals by an amplifier stage, and
determining whether a bypass line is present and bypassing the amplifier stage, with the amplifier stage being switched off when the bypass line is connected in the signal path.

19. The method according to claim 18, comprising the step of
receiving at least one control signal at at least one second input for controlling the bypass line and connection and disconnection of the amplifier stage.

20. The method according to claim 18, comprising the step of
connecting the bypass line in the signal path by at least one controllable switch.

21. The method according to claim 18, wherein
the amplifier stage is preceded by a first filter, in particular a bandpass filter, in the signal path.

22. The method according to claim 18, wherein
the first output of the front-end module is preceded by a second filter, in particular a bandpass filter, in the signal path.

23. The method according to claim 18, comprising the step of:
receiving of further transmission signals at a third input from the apparatus in order to produce transmission signals.

24. The method according to claim 18, comprising
receiving of transmission signals at a fourth input from a further apparatus for production of transmission signals.

25. The method according to claim 18, wherein
receiving signals from an antenna at a fifth input, and
outputting received signals to an apparatus for processing received signals at a second output.

26. The method according to claim 23, wherein
a part of the signal path between the at least one third input and the first output of the front-end module is used as the bypass line.

27. The method according to claim 24, wherein
a part of the signal path between the at least one fourth input and the first output of the front-end module is used as the bypass line.

28. The method according to claim 25, wherein
a part of the signal path between the fifth input and the at least one second output is used as the bypass line.

29. The front-end module according to claim 18, wherein
the transmission signals which are received at the first input are based on the WLAN standard.

30. The front-end module according to claim 24, wherein the transmission signals which are received at the at least one fourth input are based on the Bluetooth standard.
